(19) United States
(12) Patent Application Publication
(10) Pub. No.: US 2007/0090294 A1
(43) Pub. Date: Apr. 26, 2007

(54) Terahertz imaging non-destructive inspection systems and methods

(75) Inventors: Morteza Safai, Seattle, WA (US); Gary E. Georgeson, Federal Way, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 11/257,370

(22) Filed: Oct. 24, 2005

(51) Int. Cl. G01J 5/02

(52) U.S. Cl. 250/341.8

(57) ABSTRACT

Provided are systems and methods using terahertz imaging techniques for performing non-destructive inspection of a structure for detection of surface recesses. A method may involve applying a terahertz-frequency absorbing liquid to a surface of the structure, whereby the liquid will naturally tend to flow into surface recesses present in the surface of the structure, removing excess liquid from the surface of the structure which has not penetrated into existing recesses in the surface of the structure, and, after excess liquid has been removed from the surface of the structure, transmitting electromagnetic radiation in the terahertz frequency range toward the surface of the structure and detecting reflections of radiation which is not absorbed at the surface of the structure. A system may use a liquid applicator, excess liquid remover, a terahertz transmitter, and a terahertz receiver to perform a terahertz imaging non-destructive inspection operation.

### FIELD OF THE INVENTION

The present invention relates generally to an apparatus and method for inspecting a structure and, more particularly, to using terahertz imaging techniques for performing non-destructive inspection of a structure for detection of surface recesses in metal or composite materials.

### BACKGROUND

Non-destructive inspection (NDI) of structures involves thoroughly examining a structure without harming the structure or requiring its significant disassembly. Non-destructive inspection is typically preferred to avoid the schedule, labor, and costs associated with removal of a part for inspection, as well as avoidance of the potential for damaging the structure. Non-destructive inspection is advantageous for many applications in which a thorough inspection of the exterior and/or interior of a structure is required. For example, non-destructive inspection is commonly used in the aircraft industry to inspect aircraft structures for any type of internal or external damage to or flaws in the structure. Inspection may be performed during manufacturing of a structure and/or after a structure has been put into service. For example, inspection may be required to validate the integrity and fitness of a structure for continued use in manufacturing and future ongoing use in-service.

Among the structures that are routinely non-destructively tested are metal and composite structures, such as composite sandwich structures and other adhesive bonded panels and assemblies. A shift toward bonded materials dictates that devices and processes are available to ensure structural integrity, production quality, and life-cycle support for safe and reliable usage of bonded materials. In this regard, composite structures are commonly used throughout the aircraft industry because of the engineering qualities, design flexibility and low weight of composite structures, such as the stiffness-to-weight ratio of a composite sandwich structure. As such, it is frequently desirable to inspect composite structures to identify any flaws, such as surface recesses, including cracks, voids, porosity, and other surface defects, which could adversely affect the performance of the composite structure. However, non-destructive inspection of metal materials also remains an important task for ensuring the integrity of many structures.

Various types of techniques and sensors may be used to perform non-destructive inspection. One technique for non-destructive inspection is liquid penetrant inspection. Conventional liquid penetrant inspection techniques use a liquid penetrant chemical which is uniquely visible by a detection method for identifying surface recesses in a structure. A chemical is applied to a surface of a structure for inspection, allowing the chemical to penetrate into surface recesses, a solvent or like cleaner/remover chemical is used for removing excess penetrant chemical from the surface of the structure. Then a detection method, such as applying ultraviolet light in a dark room, is used to identify the location of the penetrant chemical which remains in surface recesses. While effective, conventional liquid penetrant inspection techniques are cumbersome, requiring the use of chemicals that can pose hazards, the ongoing purchase and disposal of the chemicals, the use of aerosol for solvent cleaning/remover chemicals, and the availability of darkened conditions for imaging and detecting the remaining chemical in surface recesses. Other common techniques for non-destructive inspection involve moving one or more sensors over the portion of the structure to be examined and receiving data regarding the inspection of the structure. For example, a pulse-echo (PE), through transmission (TT), or shear wave sensor may be used to obtain ultrasonic data, such as for thickness gauging, detection of laminar defects and porosity, and/or crack detection in the structure. Resonance, pulse echo or mechanical impedance sensors may be used to provide indications of voids or porosity, such as in adhesive bondlines of the structure. High resolution inspection of aircraft structure is commonly performed using semi-automated ultrasonic testing (UT) to provide a plan view image of the part or structure under inspection. While solid laminates may be inspected using one-sided pulse echo ultrasonic (PEU) testing, composite sandwich structures typically require through-transmission inspection, such as through-transmission ultrasonic (TTU) testing for high resolution inspection. In through-transmission ultrasonic inspection, ultrasonic sensors such as transducers, or a transducer and a receiver sensor, are positioned facing the other but contacting opposite sides of the structure. An ultrasonic signal is transmitted by at least one of the transducers, propagated through the structure, and received by the other transducer. Through-transmission testing may also be used with other inspection signals, such as x-rays. Data acquired by sensors, such as TTU transducers, is typically processed by a processing element, and the processed data may be presented to a user via a display. However, many structures are difficult to accurately inspect using pulse echo or through transmission or inspection. And while useful in some instances, conventional liquid penetrant inspection techniques are not ideal in many situations.

Non-destructive inspection typically is performed in one of three ways: manually, semi-automatically, or automatically. Each manner of inspection may be applicable to different inspection methods and may be better suited for particular inspection applications. For example, conventional liquid penetrant inspection is usually performed manually, but pulse echo and through-transmission inspection is often performed semi-automatically or automatically, although may also be performed manually. Manual scanning generally consists of a trained technician holding a sensor and moving the sensor along the structure to ensure the sensor is capable of testing all desired portions of the structure. In many situations, the technician must repeatedly move the sensor side-to-side in one direction while simultaneously indexing the sensor in another direction. For a technician standing beside a structure, the technician may repeatedly move the sensor right and left, and back again, while indexing the sensor between each pass. In addition, because the sensors typically do not associate location information with the acquired data, the same technician who is manually scanning the structure must also watch the sensor display while scanning the structure to determine where the defects, if any, are located in the structure. The quality of the inspection, therefore, depends in large part upon the technician's performance, not only regarding the motion of the sensor, but also the attentiveness of the technician in interpreting the displayed data. Manual inspection may also involve additional activities, such as using solvent cleaner/remover chemicals for a conventional liquid penetrant inspection. Thus, manual scanning of structures can be time-consuming, labor-intensive, and prone to human error. In addition, typical x-ray inspection applications operate with high power emissions which typically prevent most types of manual NDI x-ray inspection.

Semi-automated inspection systems have been developed to overcome some of the shortcomings with manual inspection techniques. For example, the Mobile Automated Scanner (MAUS®) system is a mobile scanning system that generally employs a fixed frame and one or more automated scanning heads typically adapted for ultrasonic inspection. A MAUS system may be used, for example, with pulse-echo, shear wave, and through-transmission sensors. The fixed frame may be attached to a surface of a structure to be inspected by vacuum suction cups, magnets, or like affixation methods. MAUS systems may have a portable head that is manually moved over the surface of a structure by a technician. However, for through-transmission ultrasonic inspection and x-ray inspection, a semi-automated inspection system requires access to both sides or surfaces of a structure which, at least in some circumstances, will be problematic, if not impossible, particularly for semi-automated systems that use a fixed frame for control of automated scan heads.

Automated inspection systems have also been developed to overcome the myriad of shortcomings with manual inspection techniques. For example, the Automated Ultrasonic Scanning System (AUSS®) system is a complex mechanical scanning system that employs through-transmission ultrasonic inspection. The AUSS system can also perform pulse echo inspections, and simultaneous dual frequency inspections. The AUSS system has robotically controlled probe arms that must be positioned proximate the opposed surfaces of the structure undergoing inspection with one probe arm moving an ultrasonic transmitter along one surface of the structure, and the other probe arm correspondingly moving an ultrasonic receiver along the opposed surface of the structure. Another example robotic system is the x-ray inspection system used at the William-Gateway Structured Repair Facility is Mesa, Arizona, for inspection of F-18 tail sections. Conventional automated scanning systems, such as the AUSS-X system and the William-Gateway x-ray system, therefore require access to both sides of a structure which, at least in some circumstances, will be problematic, if not impossible, particularly for very large or small structures. To maintain the transmitter and receiver in proper alignment and spacing with one another and with the structure undergoing inspection, the AUSS-X system has a complex positioning system that provides motion control in ten axes. This requirement that the orientation and spacing of the transmitter and receiver be invariant with respect to one another and with respect to the structure undergoing inspection is especially difficult in conjunction with ultrasonic inspection of curved structures.

Accordingly, a need exists for improved non-destructive inspection systems and methods to inspect structures which may be used instead of conventional non-destructive inspection systems, devices, and methods such as those described above.

### SUMMARY OF THE INVENTION

The present invention provides systems and methods for using terahertz imaging techniques for performing non-destructive inspection of a structure for detection of surface recesses in metal or composite materials. Embodiments of systems and methods of the present invention operate in the terahertz (THz) gap in the electromagnetic spectrum which lies between microwave and infrared frequencies and generally refers to electromagnetic frequencies from 100 GHz (10¹¹ Hz, 3 mm wavelength) to 30 THz (3×10¹³ Hz, 1 μm wavelength). Electromagnetic radiation in the terahertz frequency range may also be referred to as terahertz light.

One embodiment of a method for inspecting a structure in accordance with the present invention involves applying a liquid to a surface of the structure that absorbs radiation at terahertz-frequencies in a different manner than the underlying structure. For example, the liquid may be a terahertz frequency absorbing liquid. The liquid will naturally tend to flow into surface recesses present in the surface of the structure. The method then involves the removal of excess liquid from the surface of the structure which has not penetrated into existing recesses in the surface of the structure. After excess liquid has been removed from the surface of the structure, electromagnetic radiation in the terahertz frequency range is transmitted toward the surface of the structure, and reflections of radiation which is not absorbed at the surface of the structure are received. An embodiment of a method of the present invention may use electromagnetic radiation in the frequency range from 100 GHz to 30 THz. Further, an embodiment of a method of the present invention may create a visual image of absorption or reflection at the surface of the structure, thereby providing a visual indication of surface recesses in the structure.

In one embodiment of a method of the present invention, water is used as the liquid. In an embodiment of a method of the present invention which uses water as the terahertz-absorbing liquid, the transmitted electromagnetic radiation may be in the frequency range of 100 GHz to 2.3 THz, a range in which water exhibits absorptive characteristics with respect to electromagnetic radiation. In another embodiment of a method of the present invention, the liquid may be applied to the surface of the structure by spraying the liquid onto the surface of the structure.

An embodiment of a method of the present invention may remove excess liquid from the surface of the structure by such techniques as wiping the surface, allowing the excess liquid to evaporate, or directing heat or heated air toward the surface of the structure to accelerate the evaporation of excess liquid from the surface.

An embodiment of a method of the present invention may be used for scanning at least a portion of the surface of a structure, such as to create a two dimensional representation of the scanning of the surface of the structure. In an embodiment of a method of the present invention for scanning at least a portion of the surface of the structure, the position of the inspection may be automatically correlated with the surface of the structure, such as where a conventional inspection software application is applied to the data received from a terahertz inspection operation.

In another embodiment of a method for inspecting an aircraft structure in accordance with the present invention involves applying a liquid to a surface of the aircraft structure, the liquid being absorbent of electromagnetic radiation in a terahertz frequency range, and transmitting electromagnetic radiation in the terahertz frequency range toward the surface of the aircraft structure, such as a composite aircraft structure.

A further embodiment of a method for inspecting an aircraft structure in accordance with the present invention involves transmitting electromagnetic radiation in a terahertz frequency range toward a surface of the aircraft structure, where the surface has a terahertz-absorbent liquid received in recesses in the structure, and receiving electromagnetic radiation reflected by the aircraft structure. The frequency of transmitted and received electromagnetic radiation may be in the 100 GHz to 30 THz range, such as from 100 GHz to 2.3 THz range if water is used as the terahertz-absorbent liquid. A method may also create a visual image of absorption of the terahertz radiation by the liquid and/or reflection of the terahertz radiation by the structure.

One embodiment of a system for inspecting a structure in accordance with the present invention uses a terahertz electromagnetic radiation system and a computer. The structure includes a terahertz-absorbent liquid received in recess of the structure. The terahertz electromagnetic radiation system may be configured to transmit electromagnetic radiation in a terahertz frequency range toward a surface of the structure for absorption by the liquid, receive radiation reflected by the structure, and generate a signal indicative of the received radiation. The computer, in communication with the terahertz electromagnetic radiation system, may be configured to process the generated signal, and may further be configured for creating a visual image of absorption of the electromagnetic radiation transmitted by the terahertz electromagnetic radiation system, such as to present to a user on a display.

One embodiment of a system for inspecting a structure in accordance with the present invention also uses a liquid applicator and an excess liquid remover, and the terahertz electromagnetic radiation system includes a terahertz transmitter and a terahertz receiver. The liquid applicator applies liquid to a surface of the structure. The excess liquid remover removes excess of liquid from the surface of the structure which has not penetrated into existing recesses in the surface of the structure. The terahertz transmitter transmits electromagnetic radiation toward the surface of the structure in a frequency selected to allow for absorption of at least a portion of the radiation at the surface of the structure, such as by liquid remaining at the surface of the structure which penetrated into an existing surface recess in the surface of the structure. The terahertz receiver receives reflected radiation by the structure. An embodiment of a system of the present invention may use an absorbing material, heater, or heated air blower for the excess liquid remover.

In one embodiment of a system of the present invention, the liquid applicator is capable of applying water to the surface of the structure for using water as the liquid. In an embodiment of a system of the present invention which uses a liquid applicator capable of applying water as the terahertz-absorbing liquid, the tetrahertz transmitter may be configured for transmitting electromagnetic radiation in the frequency range of 100 GHz to 2.3 THz, a range in which water exhibits absorptive characteristics with respect to electromagnetic radiation.

An embodiment of a system of the present invention may use a positional scanner for supporting the terahertz transmitter and terahertz transducer for scanning at least a portion of the surface of the structure.

In one embodiment of a system of the present invention, the terahertz receiver includes a viewing portion that is configured for wearing on a human head and for providing an inspection operator the ability to immediately view the location of terahertz radiation absorbed by liquid remaining on the surface of the structure during an ongoing inspection operation.

These and other characteristics, as well as additional details, of the present invention are further described in the Detailed Description with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a flow diagram of one embodiment of a method for inspection a structure in accordance with the present invention;

FIG. 2 is a pictorial diagram of an on-aircraft non-destructive inspection operation in accordance with an embodiment of the present invention; and

FIG. 3 is a schematic diagram of a system for inspecting a structure in accordance with an embodiment of the present invention.

### DETAILED DESCRIPTION

The present invention will be described more fully with reference to the accompanying drawings. Some, but not all, embodiments of the invention are shown. The invention may be embodied in many different forms and should not be construed as limited to the embodiments described. Like numbers and variables refer to like elements and parameters throughout the drawings.

An embodiment of the present invention may be used to inspect a variety of structures formed of various materials. Structures that may be inspected with an embodiment of an inspection device of the present invention may include, but are not limited to, metals, composites, non-ferromagnetic metals (e.g. aluminum alloy, titanium alloy, or aluminum or titanium hybrid laminates such as GLARE or Ti/Gr), and polymers. For operation of a system or method of the present invention using terahertz electromagnetic radiation, the material of the structure must be relatively less, or relatively more, absorbent than a liquid applied to the surface of the structure to allow for an observation of the contrast between absorbed and reflected terahertz electromagnetic radiation. Although a material, such as a composite material, may be only partially reflective of terahertz electromagnetic radiation, the material need only be relatively non-absorbent compared to a liquid applied to the surface of the structure. Structures may be any myriad of shapes and/or sizes. In addition, the structure that is inspected may be used in a wide variety of applications, including in vehicular applications, such as in conjunction with aircraft, marine vehicles, automobiles, spacecraft and the like, as well as other non-vehicular applications, such as in conjunction with buildings and other construction projects. Moreover, the structure may be inspected prior to assembly or following assembly, as desired, such as on a factory floor, at a maintenance depot, or even at an in-service location such as on an airport tarmac.

Embodiments of systems and methods operating in accordance with the present invention take advantage of recent developments in terahertz transmitters and receivers, such as ultra-fast pulsed lasers that can generate broad bandwidth terahertz electromagnetic radiation. Embodiments of the present invention also take advantage of unique characteristics of terahertz electromagnetic radiation, particularly the absorption of terahertz electromagnetic radiation by water and the reflection of terahertz electromagnetic radiation by metal and composite materials. Because absorption and reflection of terahertz electromagnetic radiation varies between different materials, terahertz technologies may be used for non-destructive inspection techniques, such as the present invention.

Embodiments of the present invention provide a non-destructive inspection technique that is simple to implement and provide an alternative to conventional liquid penetrant inspection techniques. Embodiments of the present invention provide a single-sided, full field capable inspection technique that may be implemented in real-time, such as a two-dimensional imaging that may be depicted on a monitoring display, such as a CRT or LCD display. Unlike conventional liquid penetrant inspection techniques, embodiments of the present invention do not require the use of penetrant chemicals that can pose hazards and require ongoing purchase and disposal of the chemicals and/or storage containers such as aerosol cans for solvent cleaning removers. For example, conventional liquid penetrant inspection techniques typically involve a fluorescent red dye penetrant requiring a developer chemical, darkened conditions, such as a dark room, and ultraviolet lighting for detecting the liquid penetrant in surface recesses. Another advantage of terahertz technologies is that terahertz electromagnetic radiation is safe to the human eye and does not require radiation shielding.

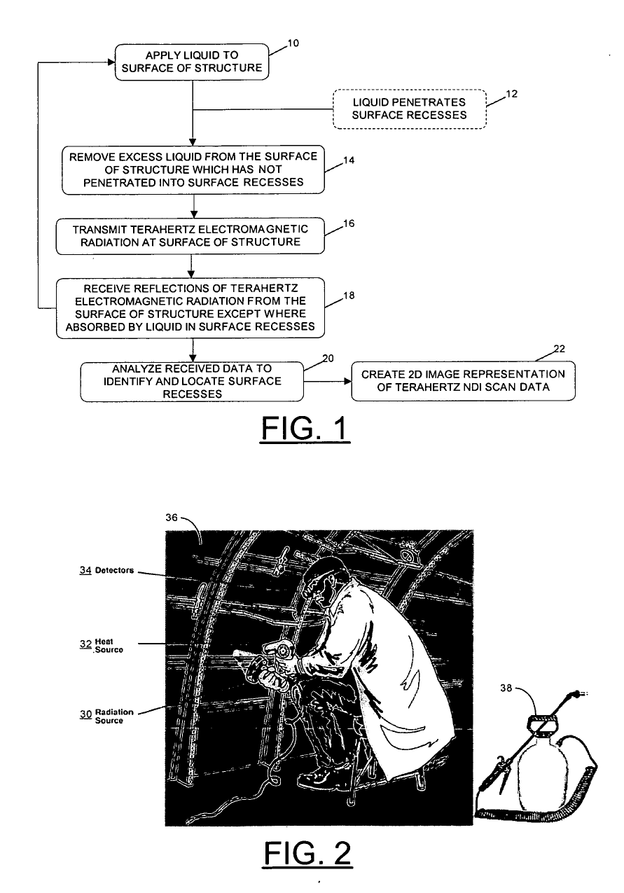

The operation of an embodiment of the present invention is described with reference to FIG. 1. Inspection techniques according to the present invention rely upon the difference between reflection and absorption of a liquid and the material of a structure. Accordingly, a liquid is applied to a surface of the structure being inspected 10. The liquid has the property of absorbing electromagnetic radiation in the terahertz frequency range, such as water which absorbs terahertz electromagnetic radiation above 1.3 THz (with wavelengths longer than 23 μm). However, because the present invention merely relies upon a relative difference between reflection and absorption of a liquid and the material of a structure, it would also be possible to practice the present invention using a liquid which is relatively reflective of terahertz electromagnetic radiation with a material of the structure which is relatively absorbent of terahertz electromagnetic radiation in comparison to the liquid. Typically, however, because of the reflective characteristic of metals and composite materials with respect to terahertz electromagnetic radiation, a liquid, such as water, is used that is relatively absorbent of terahertz electromagnetic radiation.

The liquid may be applied in various manners using any sort of liquid applicator, such as a brush, rag, hand sprayer, pressure pump sprayer, hose, humidifier, fan mister, steam mister, and like devices which are capable of applying a liquid to a surface of a structure. For example, water may be sprayed on to a surface of a structure using a pressure pump sprayer. Once the liquid has been applied to the surface of the structure, the liquid will naturally tend to penetrate into surface recesses, such as cracks, due to surface tension of the liquid pulling the liquid into the dry recess 12. The water molecules within the body of a liquid tend to be attracted equally in all directions, so that the water experiences no net force toward the interior of the liquid. On the other hand, a water molecule at the surface of the liquid feels a net attraction from the atoms in the adjacent solid due to the surface tension between the water and the adjacent solid. As a result, there is a tendency for spreading of the water onto all surfaces including cracks and pits, sometimes with some help from gravity. The only obstacles for water to penetrate inside cracks are the surface tension and capillary action of the water itself. However, the surface tension of water may be substantially reduced by applying a small amount of soap, detergent, or similar substance to the water for decreasing the surface tension of the water, where the applied substance may rapidly spread across the surface. Once the water has reached equilibrium because of the week molecular forces of the water, any rise in temperature can create vaporization of the liquid into gas. However, in order to increase vaporization and to ensure no water molecules have been left in a crack before any repair, the water can be mixed with a liquid with a lower boiling point, such as alcohol. A water-alcohol mix can be tailored for selective evaporation rates. Some composites that contain un-removed moisture can be damaged when subjected to thermal changes. Accordingly, it may be important that the composite be thoroughly dried after an inspection that required liquids.

After having applied the liquid 10, and thereby provided the liquid the opportunity to penetrate into surface recesses 12, excess liquid on the surface of the structure which has not penetrated into a surface recess is removed 14 using any sort of excess liquid remover, such a rag, sponge, or like liquid absorbent material to wipe and/or absorb excess liquid. Another excess liquid remover is a squeegee or like wiping and/or scraping device to push or pull excess liquid from the surface of the structure. A fan or similar blowing device may be used as an excess liquid remover to remove excess liquid from the surface of the structure. Other liquid removers may rely, at least in part, on evaporation of the liquid to remove excess liquid from the surface of the structure. Excess liquid may be passively permitted to evaporate or actively evaporated. For example, a heat source may be used as an excess liquid remover to accelerate evaporation of excess liquid on the surface of the structure. A heat source may use conduction, convection, radiation, or a combination of heat transfer techniques to increase the temperature of excess liquid directly, or possibly indirectly by increasing the heat of the structure, to increase the evaporation of excess liquid. Because heat may also affect liquid which has penetrated into a surface recess in the structure, an excess liquid remover may advantageously rely, at least in part, on the presence of the excess liquid being on the surface of the structure and, therefore, susceptible to influence by airflow adjacent to the surface of the structure. As such, other excess liquid remover which may advantageously be used with embodiments of the present invention blow air onto and/or across the surface of the structure to accelerate evaporation of excess liquid at the surface of the structure. An excess liquid remover may also be a combination of any of the above referenced excess liquid removers, such as a heated air blower which combines the use of heat and blowing air to accelerate evaporation, thereby removal, of excess liquid at the surface of the structure. Because water may typically be used as the liquid and excess water may be removed, for example, by dry wiping the surface or evaporation, another advantage of the present invention is that there typically is no need for an excess liquid capture or recycling mechanism, such as a catch pan and reservoir tank, thereby reducing the complexity and requirements for performing non-destructive inspection of a structure using an embodiment of a method or system of the present invention.

After removing excess liquid which remains at the surface of the structure and did not penetrate into a surface recess, the only remaining liquid will be the liquid which penetrated into surface recesses. A portion of the liquid that penetrated into the recesses will naturally tend to seep out of the recess onto the surface of the structure due to surface tension and capillary action, thereby reversing the effect of the water naturally penetrating into the dry recesses; the surface of the structure and the liquid seeping to the surface from the surfaces recesses may then be subjected to terahertz electromagnetic radiation.

A terahertz transmitter may be used to transmit electromagnetic radiation in the terahertz frequency range of 100 GHz to 30 THz toward the surface of the structure 16 which now has been removed of excess liquid which did not penetrate into a surface recess. Further, liquid which penetrated into surface recesses now is present at the surface of the structure due to surface tension and capillary properties and is present for exposure to the terahertz electromagnetic radiation from the terahertz transmitter. This exposed liquid seeping from the surface recesses will absorb the terahertz electromagnetic radiation at the location of surface recesses, but the surrounding material of the surface will reflect the terahertz electromagnetic radiation, thereby providing an absorption-reflection contrast that identifies the location of surface recesses in the structure. A terahertz receiver may be used to detect/receive terahertz radiation in the terahertz frequency range of 100 GHz to 30 THz which is reflected from the surface of the structure 18, such as where terahertz radiation may be reflected by metal portions of the surface but not at surface recess locations where water is present and absorbs the terahertz radiation. The data from the reflected and received terahertz electromagnetic radiation may then be analyzed to determine the location of surface recesses in the structure 20. The data may also be used, for example, to create a visual image of absorption or reflection of terahertz electromagnetic radiation at the surface of the structure 22, thereby providing a visual image of the location of surface recesses where remaining liquid has absorbed at least a portion of the transmitted radiation in comparison to the reflection of at least a portion of the transmitted radiation. If the liquid is relatively absorbent of the terahertz radiation, and the material of the structure is relatively non-absorbent, then the contrast between absorption and reflection of the terahertz radiation may be used to create the image of the structure identifying the location of surface recesses. For example, a two-dimensional image may be created that combines the inspection data with a graphical representation of the structure and which can be used to interpret the inspection data to locate surface recesses in the structure where terahertz electromagnetic radiation was absorbed by liquid in a surface recess.

Embodiments of the present invention may be capable of detecting surface recesses as small as a few micrometers in width depending upon the spatial resolution of the detection, which generally depends at least in part on the inspection wavelength and the collection optics of the terahertz receiver.

Embodiments of the present invention may be performed manually or may use an AUSS or MAUS system or other automated or semi-automated system as a positional scanner, at least for certain aspects of the inspection technique. For example, while the application of the liquid and removal of excess liquid may be performed manually, the transmission of terahertz electromagnetic radiation from a terahertz transmitter and subsequent detection of reflected terahertz radiation by a terahertz receiver may be controlled by a semi-automatic or automatic system, thereby enabling the use of computer controls for performing the terahertz inspection and capture of the inspection data. Using a semi-automatic or automatic system also provides computerized correlation between the surface of the structure under inspection and the inspection data for creating an image of the surface of the structure in relation to the inspection data. Using a semi-automatic or automatic system also provides the ability to ensure complete inspection of a surface of a structure, whereby the semi-automatic or automatic system may keep track of what portions of the surface of the structure have been inspected and what portions remain to be inspected if so desired. If a semi-automatic or automatic system is used, it may be referred to as a positional scanner for supporting the terahertz transmitter and/or terahertz receiver, positioning the terahertz transmitter and/or terahertz receiver with respect to the surface of the structure under inspection, and scanning the surface of the structure for terahertz imaging. For example, a positional scanner may be used to support a terahertz transmitter at a chosen incident angle with respect to the surface of a structure and to support a terahertz receiver at a chosen reflection angle with respect to the surface of the structure.

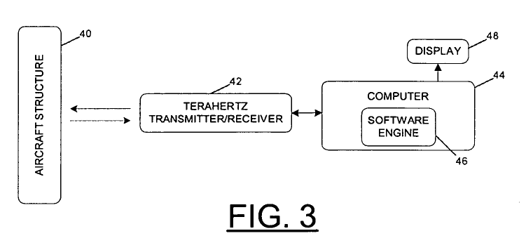

FIG. 2 is a pictorial diagram of an on-aircraft non-destructive inspection operation in accordance with an embodiment of the present invention. The inspection operation of FIG. 2 involves manually inspecting an interior surface 36 of a structure on an aircraft using an embodiment of a terahertz imaging non-destructive inspection method in accordance with an embodiment of the present invention. The operator, after having applied a liquid to the surface of the structure, such as spraying water from a pump sprayer 38, removes excess liquid that remains on the surface 36 and has not penetrated into surface recesses, such as using a heated blow dryer 32 to evaporate excess water. The operator then uses a terahertz electromagnetic radiation source, such as a portable terahertz transmitter 30, to project terahertz light upon a portion of the surface 36 of the structure. At the same time, the operator views the reflection of terahertz electromagnetic radiation from the surface 36 with a terahertz receiver, such as terahertz detectors 34 which may be worn by the operator and provide the operator the ability to see the reflection of terahertz light from the surface and the absence of reflection caused by absorption of the terahertz light by water remaining in surface recesses. While the terahertz detectors 34 may be worn by the operator, the portion of the terahertz receiver worn by the operator may only include optics and image capture hardware for receiving and detecting the reflected terahertz light and a viewing portion for presenting an image of the detected terahertz light; the image capture hardware and viewing portion may be connected to a separate processing device, such as a computer, which may convert the inspection data from the image capture hardware into a visual image that can be presented to the user on the viewing portion, such as using a miniature LCD heads-up display which overlays the operator's vision of the surface of the structure. While the terahertz transmitter and terahertz receiver are shown in FIG. 2 as separate devices, an embodiment of the present invention may use a single terahertz transceiver device.

FIG. 3 is a schematic diagram of a system for inspecting a structure, such as an aircraft structure 40, in accordance with the present invention. A terahertz electromagnetic radiation system, such as a terahertz transceiver or a terahertz transmitter and a terahertz receiver pair 42, may be used, as described above, for transmitting electromagnetic radiation in a terahertz frequency range toward a surface of the structure for absorption by a liquid on the surface of the structure which is received in recesses in the surface. The terahertz electromagnetic radiation system can then receive radiation reflected by the structure, such as in areas of the structure where the liquid is not present, i.e., areas of the surface which are not cracked or pocketed with recesses. The terahertz electromagnetic radiation system may then generate signals indicative of the received radiation, such as an electronic signal representing the amount of radiation received at a given location such that recesses are identified as having lower amounts of reflection due to absorption of the electromagnetic radiation by the liquid present in the recesses. A computer 44 in communication with the terahertz electromagnetic radiation system may process the generated signals, such as using a software engine 46 operating 2-dimensional inspection software. The computer 44 may create a visual image of the reflection and/or absorption of radiation as detected by the terahertz electromagnetic radiation system, such as to present to a user on a display 48. Additional features and characteristics of the present invention may be used on this and other embodiments of systems operating in accordance with the present invention.

The present invention provides systems and methods using terahertz imaging techniques for performing non-destructive inspection of a structure for detection of surface recesses in metal or composite materials. Embodiments of methods of the present invention may involve applying a terahertz-frequency absorbing liquid to a surface of the structure, whereby the liquid will naturally tend to flow into surface recesses present in the surface of the structure, removing excess liquid from the surface of the structure which has not penetrated into existing recesses in the surface of the structure, and, after excess liquid has been removed from the surface of the structure, transmitting electromagnetic radiation in the terahertz frequency range toward the surface of the structure and detecting reflections of radiation which is not absorbed at the surface of the structure. An embodiment of a method of the present invention may further involve creating a visual image of absorption or reflection at the surface of the structure, thereby providing a visual indication of surface recesses in the structure. An embodiment of a system according to the present invention may use a liquid applicator, excess liquid remover, a terahertz transmitter, and a terahertz receiver to perform a terahertz imaging non-destructive inspection operation in accordance with the present invention. A positional scanner may be used for supporting the terahertz transmitter and/or terahertz receiver.

Many modifications and other embodiments of the inventions set forth will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed, they are used in a generic and descriptive sense only and not for purposes of limitation.

1. A method of inspection an aircraft structure, the method comprising:
applying a liquid to a surface of the aircraft structure such that the liquid is able to penetrate recesses in the surface of the aircraft structure, the liquid being absorbent of electromagnetic radiation in a terahertz frequency range; and
transmitting electromagnetic radiation in the terahertz frequency range toward the surface of the aircraft structure.

2. The method of claim 1, wherein the step of applying the liquid to the surface of the aircraft structure comprises applying the liquid to a composite aircraft structure.

3. The method of claim 1, further comprising the step of removing excess liquid from the surface of the aircraft structure which has not penetrated recesses in the surface of the aircraft structure.

4. The method of claim 1, further comprising the step of receiving a reflection of electromagnetic radiation in the terahertz frequency range from the surface of the aircraft structure.

5. A method of inspecting an aircraft structure, the method comprising:
transmitting electromagnetic radiation in a terahertz frequency range toward a surface of the aircraft structure, the surface having a terahertz-absorbent liquid received in recesses in the structure; and
receiving electromagnetic radiation in the terahertz frequency range reflected by the aircraft structure.

6. The method of claim 5, wherein the step of transmitting electromagnetic radiation in the terahertz frequency range comprises transmitting electromagnetic radiation in the frequency range from 100 GHz to 2.3 THz.

7. The method of claim 5, wherein the step of transmitting electromagnetic radiation in the terahertz frequency range comprises transmitting electromagnetic radiation in the frequency range from 100 GHz to 30 THz.

8. The method of claim 5,further comprising the step of creating a visual image of absorption of transmitted radiation on the surface of the structure.

9. A method of inspecting a structure comprising:
applying a liquid to a surface of the structure such that the liquid is able to penetrate into existing surface recesses in the surface of the structure, the liquid having an absorbency that is different than the structure for electromagnetic radiation in a terahertz frequency range; and
transmitting electromagnetic radiation in the terahertz frequency range toward the surface of the structure.

10. The method of claim 9, further comprising the step of removing excess liquid from the surface of the structure which has not penetrated into existing recesses in the surface of the structure.

11. The method of claim 9, further comprising the step of receiving a reflection of electromagnetic radiation in the terahertz frequency range from the surface of the structure.

12. The method of claim 9, wherein the step of applying a liquid to the surface of the structure comprises applying water to the surface of the structure.

13. The method of claim 12, wherein the step of transmitting electromagnetic radiation in the terahertz frequency range comprises transmitting electromagnetic radiation in the frequency range from 100 GHz to 2.3 THz.

14. The method of claim 9, wherein applying a liquid to the surface of the structure comprises spraying the liquid onto the surface of the structure.

15. The method of claim 9, wherein the step of removing excess liquid comprises wiping the surface of the structure.

16. The method of claim 9, wherein the step of removing excess liquid comprises allowing excess liquid to evaporate from the surface of the structure.

17. The method of claim 9, wherein the step of removing excess liquid comprises directing heat towards the surface of the structure to accelerate evaporation of excess liquid from the surface of the structure.

18. The method of claim 9, wherein the step of removing excess liquid comprises directing heated air towards the surface of the structure to accelerate evaporation of excess liquid from the surface of the structure.

19. The method of claim 9, wherein the step of transmitting electromagnetic radiation in the terahertz frequency range comprises transmitting electromagnetic radiation in the frequency range from 100 GHz to 30 THz.

20. The method of claim 9, further comprising the step of creating a visual image of absorption of transmitted radiation on the surface of the structure.

21. The method of claim 20, wherein the step of creating a visual image comprises creating a two dimensional representation of the surface of the structure.

22. The method of claim 9, further comprising the step of creating a visual image of reflection of transmitted radiation from the surface of the structure.

23. The method of claim 9, further comprising the steps of:
scanning at least a portion of the surface of the structure by transmitting electromagnetic radiation in the terahertz frequency range toward the portion of the surface of the structure and receiving the reflection of radiation from the portion of the surface of the structure; and
creating a visual image of absorption of transmitted radiation on the surface of the structure.

24. The method of claim 23, wherein the step of scanning at least a portion of the structure comprises automatically correlating the position of transmitted and received radiation in relation to the surface of the structure.

25. The method of claim 23, wherein the step of creating a visual image comprises creating a two dimensional representation of the scanning of the surface of the structure.

26. A system for inspecting a structure which includes a terahertz-absorbent liquid received in recesses of the structure, the system comprising:
a terahertz electromagnetic radiation system configured to:
transmit electromagnetic radiation in a terahertz frequency range toward a surface of the structure for absorption by the liquid;
receive radiation reflected by the structure; and
generate a signal indicative of the received radiation; and
a computer in communication with the terahertz electromagnetic radiation system and configured to process the generated signal from the terahertz electromagnetic radiation system.

27. The system of claim 26, wherein the terahertz electromagnetic system is further configured to transmit and receive electromagnetic radiation in at least a portion of the frequency range from 100 GHz to 30 THz.

28. The system of claim 26, wherein the computer is further configured to create a visual image of absorption of transmitted radiation on the surface of the structure.

29. The system of claim 26, further comprising:
a liquid applicator for applying the liquid to the surface of the structure to permit the liquid to be received in recesses of the structure;
an excess liquid remover for removing excess liquid from the surface of the structure;
wherein the terahertz electromagnetic radiation system comprises:
a terahertz transmitter for transmitting the electromagnetic radiation in the terahertz frequency range toward the surface of the structure; and
a terahertz receiver for receiving radiation reflected by the structure, wherein the terahertz transmitter is capable of transmitting and the terahertz receiver is capable of receiving electromagnetic radiation of the same frequency.

30. The system of claim 29, wherein the excess liquid remover comprises a heated air blower for blowing heated air towards the surface of the structure for accelerating evaporating of excess liquid from the surface of the structure.

31. The system of claim 29, further comprising a positional scanner for supporting the terahertz transmitter and terahertz receiver for scanning at least a portion of the surface of the structure.

32. The system of claim 29, wherein the terahertz receiver comprises a viewing portion that is configured for wearing on a human head and for providing an inspection operator the ability to immediately view the location of terahertz radiation absorbed by liquid remaining on the surface of the structure during an ongoing inspection operation.
